(19) United States
(12) Patent Application Publication
(10) Pub. No.: US 2026/0353076 A1
(43) Pub. Date: Nov. 5, 2026

(54) FIFTH GENERATION OVERLAYS VIRTUAL PRIVATE NETWORK WITH ZERO TOUCH PROVISIONING

(71) Applicant: TELEFONAKTIEBOLAGET LM ERICSSON (PUBL), Stockholm (SE)

(72) Inventors: Wassim Michel Haddad, Santa Clara, CA (US); Giuseppe Burgarella, Santa Clara, CA (US)

(21) Appl. No.: 19/118,688

(22) PCT Filed: Apr. 25, 2023
(86) PCT No.: PCT/IB2023/054235

§ 371 Date: Apr. 4, 2025

Related U.S. Application Data
(60) Provisional application No. 63/414,726, filed on Oct. 10, 2022.

(51) Int. Cl. H04W 12/06

(52) U.S. Cl. CPC H04W 12/06

(57) ABSTRACT

A communication device communicatively coupled to a communications network can determine (510) a plurality of dedicated security profiles associated with the communication device. The communication device can receive (530) an authentication query associated with a dedicated security profile. The communication device can determine (540) whether the dedicated security profile is one of the plurality of dedicated security profiles. The communication device can transmit (560) a query response based on whether the dedicated security profile is one of the plurality of dedicated security profiles.

### TECHNICAL FIELD

The present disclosure is related to wireless communication systems and more particularly to fifth generation (“5G”) overlays virtual private network (“VPN”) with zero touch provisioning.

### BACKGROUND

FIG. 1 illustrates an example of a New Radio (“NR”) network (e.g., a 5th Generation (“5G”) network) including a 5G Core (“5GC”) network 130, network nodes 120a-b (e.g., 5G base station (“gNB”)), multiple communication devices 110 (also referred to as user equipment (“UE”)).

In some examples, it is possible to leverage telecommunications-associated credentials in order to enable secure services offered on top of basic connectivity. When it comes to enterprise connectivity, one such example of services may be a Virtual Private Network (“VPN”) in which case, its key provisioning feature design would involve capabilities like Generic Bootstrapping Architecture (“GBA”)/Authentication and Key Management for Applications (“AKMA”), in order to leverage embedded-Subscriber Identity Module (“eSIM”) as a “trusted agent” (sometime called “root of trust”) to bridge the network and a communication device (e.g., a laptop).

While GBA functionality can be separated from the Communications Service Provider (“CSP”) infrastructure (e.g., run as part of an authentication platform, which can be separate from telecommunications infrastructure), it can be difficult to separate AKMA functionality as it is closely dependent on the output generated from running an Authentication and Key Agreement (“AKA”) protocol with the telecommunications infrastructure.

It may not be possible to run GBA/AKMA with the eSIM used to connect to a particular CSP because of security and privacy issues.

### SUMMARY

According to some embodiments, a method of operating a communication device communicatively coupled to a communications network is provided. The method includes determining a plurality of dedicated security profiles associated with the communication device. The method further includes receiving an authentication query associated with a dedicated security profile. The method further includes determining whether the dedicated security profile is one of the plurality of dedicated security profiles. The method further includes transmitting a query response based on whether the dedicated security profile is one of the plurality of dedicated security profiles.

According to other embodiments, a method of operating a dedicated security authenticator is provided. The method includes receiving an authentication request associated with a dedicated security profile. The method further includes performing an authentication procedure by communicating with a local profile assistant, LPA, selector of a communication device. The method further includes transmitting an indication of a result of the authentication procedure to a network node.

According to other embodiments, a method of operating a network node in a communications network is provided. The method includes determining information associated with a dedicated security profile. The method further includes transmitting a message to a local profile assistant, LPA, selector of the communication device, the message including the dedicated security profile and the information.

According to other embodiments, a communication device, a dedicated security authenticator, a network node, a computer program, a computer program product, a non-transitory computer readable medium, a host, or a communication system is provided to perform the methods above.

Certain aspects of the disclosure and their embodiments may provide technical advantages. Some embodiments herein enable a 5G-based VPN zero touch provisioning by leveraging 5G core features (e.g., secondary authentication), meaning relying on a trigger provided by a network entity without disclosing any credential to the network entity. In some examples, it becomes possible to select the eSIM profile that would provide the security credentials to enable such authentication to occur.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a signal flow diagram illustrating an example of a secondary authentication triggered by an allocated system management function (“SMF”);

FIG. 3 is a signal flow diagram illustrating an example of a secondary authentication run by a dedicated security profile;

FIG. 4 is a block diagram illustrating an example of a communications network including a communication device with a Local Profile Assistant (“LPA”) Selector in accordance with some embodiments;

FIG. 5 is a flow chart illustrating an example of operations performed by a communications device in accordance with some embodiments;

FIG. 6 is a flow chart illustrating an example of operations performed by a dedicated security authenticator in accordance with some embodiments;

FIG. 7 is a flow chart illustrating an example of operations performed by a network node in accordance with some embodiments;

FIG. 8 is a block diagram of a communication system in accordance with some embodiments;

FIG. 9 is a block diagram of a user equipment in accordance with some embodiments

FIG. 10 is a block diagram of a network node in accordance with some embodiments;

FIG. 11 is a block diagram of a host, which may be an embodiment of the host of FIG. 8, in accordance with some embodiments;

FIG. 12 is a block diagram of a virtualization environment in accordance with some embodiments; and

FIG. 13 shows a communication diagram of a host communicating via a network node with a user equipment over a partially wireless connection in accordance with some embodiments.

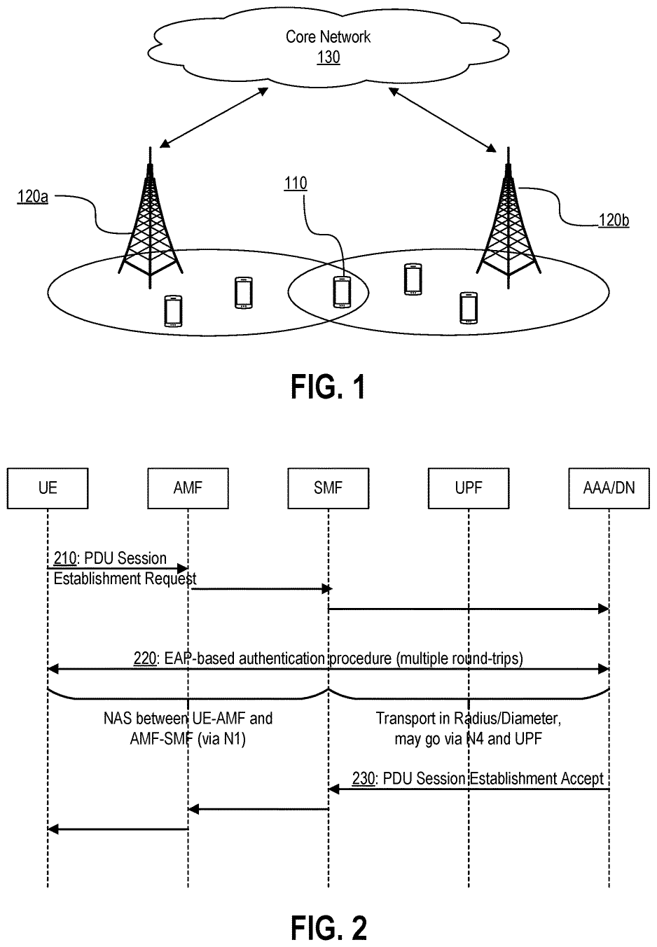

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There currently exist certain challenges. For example, there is currently no available solution that enables dynamic embedded-Subscriber Identity Module (“eSIM”) selection in a “multi-eSIM profiles” setting, in response to specific queries from a security module.

Certain aspects of the disclosure and their embodiments may provide solutions to these or other challenges. Various embodiments herein introduce a new module that can be referred to as a Local Profile Assistant (“LPA”) Selector, which complements an existing LPA module with new capabilities including deciding on and pointing a request from an Authenticating Entity (“AE”) to the correct eSIM profile, in order to run, for example, an Extensible Authentication Protocol-Authentication and Key Agreement Prime (“EAP-AKA”“) and/or Authentication and Key Management for Applications (”AKMA“) protocols, using credentials stored in the selected eSIM profile.

In order to avoid any Communications Service Provider (“CSP”) involvement in generating security credentials for Virtual Private Network (“VPN”) provisioning, it can be important to leverage a dedicated security profile that can connect to Generic Bootstrapping Architecture (“GBA”)/AKMA functionality integrated in a dedicated authentication platform.

In some embodiments, an eSIM-centric architecture is provided that can be embedded in a user devices (e.g., a laptop, a mobile, or a tablet), which can extend the device LPA capabilities to dynamically select an eSIM profile for a particular operation (e.g., a 5th Generation (“5G”)-based authentication protocol) but without sharing any security credentials (e.g., with a telecommunications provider or an Internet-of-Things (“IoT”) safe.

Secondary authentication can be triggered by a session management function (“SMF”). In some examples, the secondary authentication is triggered by the SMF following successful primary authentication (e.g., end-user device is authenticated to CSP network and allowed to connect). In additional or alternative examples, the secondary authentication can be triggered by the SMF following receipt (by allocated SMF) of a protocol data unit (“PDU”) session establishment request message sent by a communication device. The SMF can determine that the secondary authentication/authorization of the PDU Session Establishment is required based on the SMF policy associated with the data network (“DN”). The SMF can trigger the secondary authentication between the communication device and a dedicated authentication entity (which can perform the role of Extensible Authentication Protocol (“EAP”) Authenticator). The EAP server can be a part of the dedicated authentication platform.

FIG. 2 illustrates an example of a secondary authentication triggered by an allocated SMF. At block 210, a message including a PDU Session Establishment Request is transmitted (1) from the UE to the Access and Mobility Management Function (“AMF”); (2) from the AMF to the SMF; and (3) from the SMF to the Authentication, Authorization, and Accounting (“AAA”) entity/DN.

At block 220, an EAP-based authentication procedure is performed between the UE and the AAA/DN. This procedure can be divided into (1) non-access stratum (“NAS”) messages being transmitted between the UE and AMF and between the AMF and SMF via a N1 interface; and (2) transport in Radius/Diameter, which may be transmitted via an N4 interface and/or a user plane function (“UPF”). At block 230, the AAA/DN transmits an indication of the PDU Session Establishment Accept to the SMF, which gets forwarded from the SMF to the AMF, and then forwarded from the AMF to the UE.

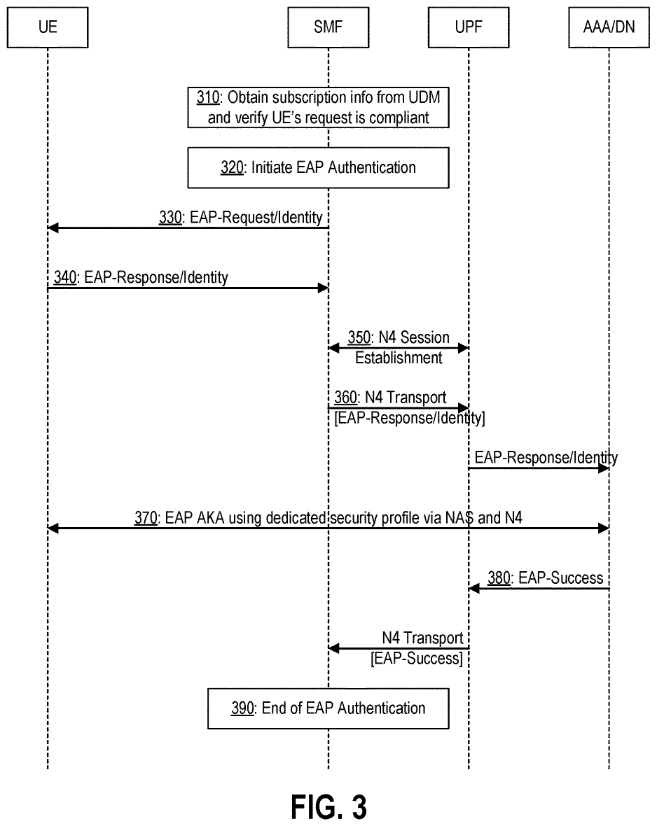

FIG. 3 illustrates an example of a dedicated security profile (e.g., a dedicated embedded-Subscriber Identity Module (“eSIM”)) running secondary authentication. At block 310, the SMF obtains subscription information from a Unified Data Management (“UDM”) node and verifies that a UE's request is compliant. At block 320, the SMF initiates EAP authentication. At block 330, the SMF transmits a EAP-Request/Identity message to the UE. At block 340, the UE transmits an EAP-Response/Identity message to the SMF. At block 350, the SMF and UPF perform N4 Session Establishment. At block 360, the SMF transmits the EAP-Response/Identity via N4 transport to the UPF, which forwards the EAP-Response/Identity to the AAA/DN. At block 370, the UE and AAA/DN perform EAP AKA using the dedicated security profile via NAS and N4. At block 380, the AAA/DN transmits a message indicating EAP-Success to the UPF, which forwards the indication of the EAP-Success to the SMF via N4 transport. At block 390, the SMF ends the EAP Authentication process.

In some embodiments, a dedicated security profile can be used to run secondary authentication. The secondary authentication can run EAP-AKA′ protocol and can lead to deriving AKMA keys. These keys can be used by a communication device to communicate securely with selected applications/services.

In additional or alternative embodiments, logic to leverage credentials from a different security profile (e.g., an eSIM profile) to run secondary authentications can be part of an operating system (“OS”) running on the communication device. In some examples, the local profile assistant (“LPA”) can be extended to include the role of a decision plane (e.g., it can point the authenticating module towards the right security profile) and if needed, facilitate the communication between the two components (e.g., by requesting the 4G/5G modem to retrieve information from the selected dedicated security profile).

Various embodiments herein make one or more of the following assumptions. In some embodiments, multiple dedicated security profiles (e.g., eSIM profiles) can be downloaded at anytime on a communication device (also referred to herein as a user equipment (“UE”) or user device).

In additional or alternative embodiments, the LPA module is capable of authorizing and pointing an Authenticating Entity (“AE”) to the right security profile. In some examples, the LPA is the entity in charge of downloading and storing security profiles from external servers (e.g., a Subscription Manager Data Preparation Platform (“SM-DP+”) server).

In additional or alternative embodiments, the AE is integrated in the operating system running on the communication device. In some examples, the AE can communicate with the “LPA decision plane” (also referred to herein as a “LPA Selector”).

In additional or alternative embodiments, at anytime, a new security profile can be downloaded on the communication device for the purpose of offering security credentials to a particular AE, in order to run a security profile-based authentication procedure with a dedicated authentication platform.

In additional or alternative embodiments, EAP-AKA′ and IoT Safe are the authentication protocols used to leverage credentials stored in an dedicated security profile.

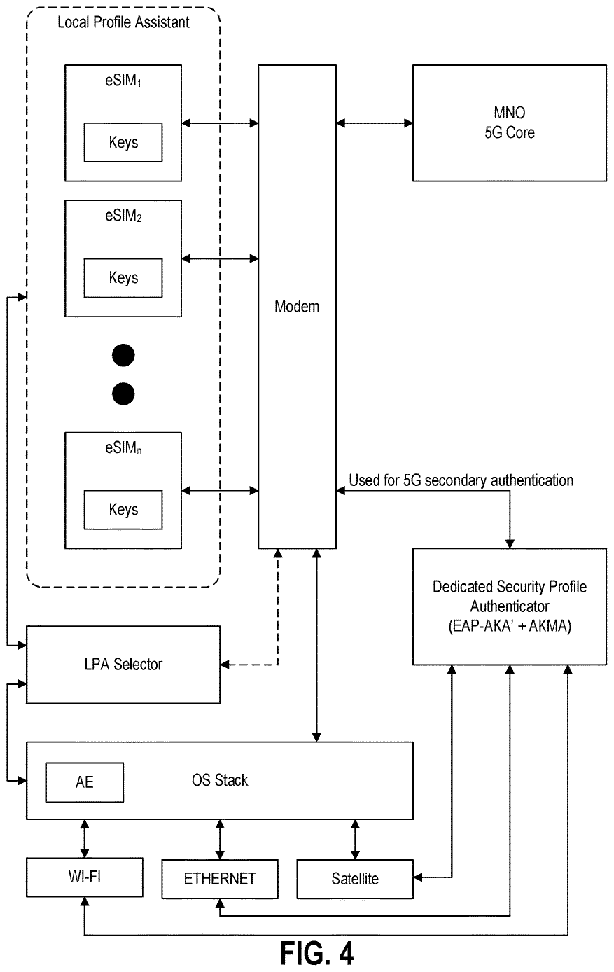

FIG. 4 illustrates an example of a communications network that includes a communication device that has a LPA Selector module. This architecture can enable any wireless/wired medium to use EAP-AKA′. The LPA module can reside in the eSIM or outside. In both cases, it needs to securely communicate with the LPA selector (which is illustrated as outside the eSIM, but in some examples may reside in the eSIM). While this example illustrates eSIMs, any suitable dedicated security profiles may be used.

In some embodiments, a procedure for 5G overlays VPN with zero touch provisioning is provided below. In some examples, upon receiving an “EAP request/Identity message” from a 5G network, an AE can query the “LPA selector” before responding to the “EAP request” message. In additional or alternative examples, a key feature to enable the LPA Selector to perform its role is the ability to add and store metadata for each downloaded eSIM profile. Such metadata can be provided by InTune during a provisioning phase and/or anytime a new eSIM profile is downloaded/upgraded.

In additional or alternative examples, when “EAP selector” receives an EAP request/id message, it responds based on pre-stored policy. For example, it can decide to leverage security credentials stored in another eSIM in which case, it will respond to AE query by sending the corresponding eSIM identifier.

In additional or alternative examples, upon receiving eSIM identifier, AE retrieves credentials from the selected eSIM profile (e.g., via the corresponding modem).

In additional or alternative examples, the same logic applies for an EAP-AKA′ authentication triggered by other access technologies (e.g., corporate/business WI-FI).

In additional or alternative examples, the LPA Selector may not always have an answer to the incoming request (e.g., it may be that the right answer is to use a certificate that is stored somewhere else). In this case, the LPA selector response can be “unavailable”, which in turn can trigger the AE to query another subsystem. Since a question of priorities may arise here, in some examples, the request can be punted first to the LPA selector before querying other subsystem.

As illustrated in FIG. 4, the dashed line between the eSIM selector and modem indicates it may be possible to extend the “eSIM selector” capabilities to go beyond the selection by requesting a copy of the credentials and responding to AE query with the credential itself.

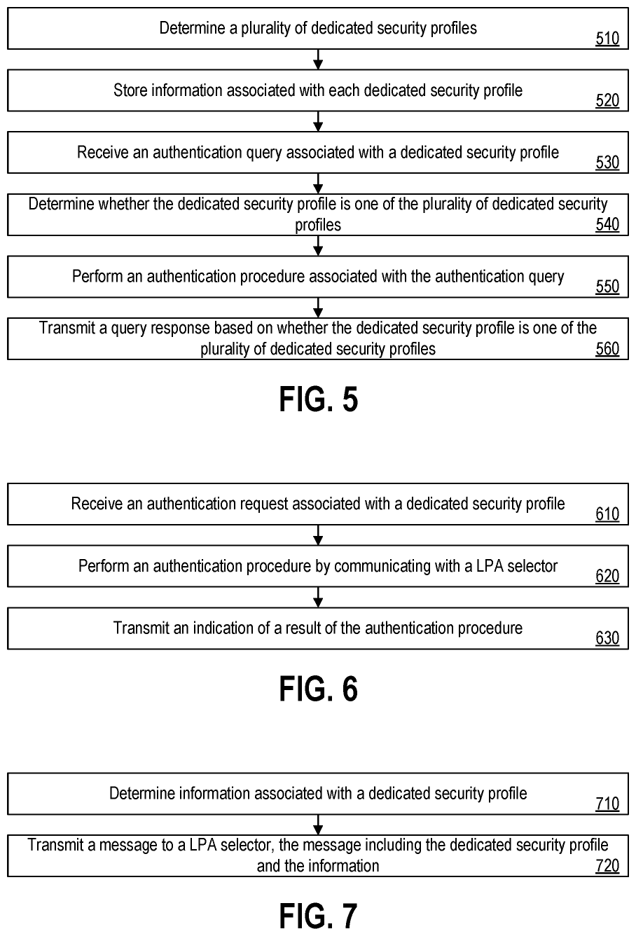

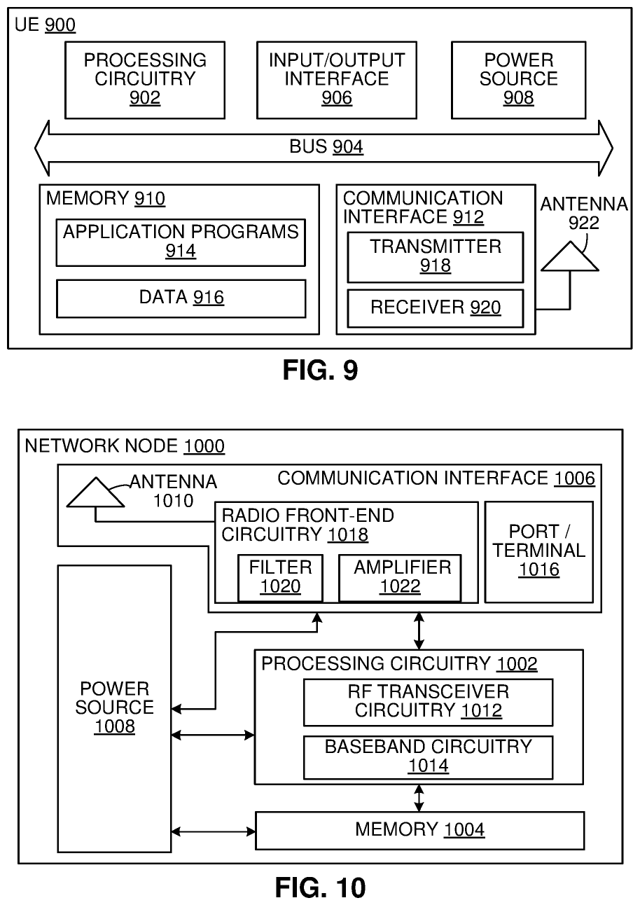

Operations of the communication device 900 (implemented using the structure of the block diagram of FIG. 9) will now be discussed with reference to the flow chart of FIG. 5 according to some embodiments of inventive concepts. For example, modules may be stored in memory 910 of FIG. 9, and these modules may provide instructions so that when the instructions of a module are executed by respective communication device processing circuitry 902, processing circuitry 902 performs respective operations of the flow chart.

FIG. 5 illustrates an example of operations performed by a communication device.

At block 510, processing circuitry 902 determines a plurality of dedicated security profiles.

At block 520, processing circuitry 902 stores information associated with each dedicated security profile. In some examples, the information is stored in a location accessible by a LPA selector of the communication device.

At block 530, processing circuitry 902 receives, via communication interface 912, an authentication query associated with a dedicated security profile. In some embodiments, receiving the authentication query includes receiving an authentication request associated with a secondary authentication from a dedicated security authenticator that is separate from the communications device.

At block 540, processing circuitry 902 determines whether the dedicated security profile is one of the plurality of dedicated security profiles. In some embodiments, determining whether the dedicated security profile is one of the plurality of dedicated security profiles includes the LPA selector determining whether the dedicated security profile is one of the plurality of dedicated security profiles based on the information.

In some examples, the LPA selector is part of an operating system of the communication device. In additional or alternative examples, the LPA selector is part of a LPA of the communication device, the LPA comprising the plurality of dedicated security profiles.

In additional or alternative embodiments, determining whether the dedicated security profile is one of the plurality of dedicated security profiles includes determining that the dedicated security profile is one of the plurality of dedicated security profiles,

At block 550, processing circuitry 902 performs an authentication procedure associated with the authentication query. In some embodiments, performing the authentication procedure associated with the authentication query includes determining, by the LPA selector, an identifier of the dedicated security profile; and transmitting the identifier of the dedicated security profile to at least one of: a LPA of the communication device; a modem of the communication device; and the dedicated security authenticator.

At block 560, processing circuitry 902 transmits, via communication interface 912, a query response based on whether the dedicated security profile is one of the plurality of dedicated security profiles. In some embodiments, transmitting the query response includes transmitting at least one of: an identifier of the dedicated security profile; and credentials stored in the dedicated security profile.

In additional or alternative embodiments, determining whether the dedicated security profile is one of the plurality of dedicated security profiles includes determining that the dedicated security profile is not one of the plurality of dedicated security profiles. Transmitting the query response includes transmitting an indication that the dedicated security profile is not one of the plurality of dedicated security profiles.

In additional or alternative embodiments, the dedicated security profile comprises an embedded-Subscriber Identity Module, eSIM.

Various operations from the flow chart of FIG. 5 may be optional with respect to some embodiments of communication devices and related methods.

Operations of the RAN node 1000 (implemented using the structure of FIG. 10) will now be discussed with reference to the flow chart of FIGS. 6-7 according to some embodiments of inventive concepts. For example, modules may be stored in memory 1004 of FIG. 10, and these modules may provide instructions so that when the instructions of a module are executed by respective RAN node processing circuitry 920, RAN node 1000 performs respective operations of the flow charts.

FIG. 6 illustrates an example of operations performed by a dedicated security authenticator.

At block 610, processing circuitry 1002 receives, via communication interface 1006, an authentication request associated with a dedicated security profile. In some embodiments, receiving the authentication request includes receiving the authentication request associated with the dedicated security profile of a plurality of dedicated security profiles stored on the communication device.

At block 620, processing circuitry 1002 performs an authentication procedure by communicating with a LPA selector. In some embodiments, performing the authentication procedure includes requesting an identifier of the dedicated security profile from the LPA selector; and receiving the identifier of the dedicated security profile from the LPA selector.

At block 630, processing circuitry 1002 transmits, via communication interface 1006, an indication of a result of the authentication procedure.

In some embodiments, the dedicated security profile includes an embedded-Subscriber Identity Module, eSIM.

FIG. 7 is a block diagram illustrating an example of operations performed by a network node.

At block 710, processing circuitry 1002 determines information associated with a dedicated security profile.

At block 720, processing circuitry 1002 transmits, via communication interface 1006, a message to a LPA selector. The message can include the dedicated security profile and the information associated with the dedicated security profile.

In some embodiments, the dedicated security profile includes an embedded-Subscriber Identity Module, eSIM.

Although FIGS. 6-7 are described in regards to a RAN node, similar operations may be performed by the Core Network CN node 1000 (implemented using the structure of FIG. 10). For example, modules may be stored in memory 1004 of FIG. 10, and these modules may provide instructions so that when the instructions of a module are executed by respective CN node processing circuitry 1002, CN node 1000 performs respective operations of the flow charts.

Various operations from the flow charts of FIGS. 6-7 may be optional with respect to some embodiments of RAN nodes, CN nodes, and related methods.

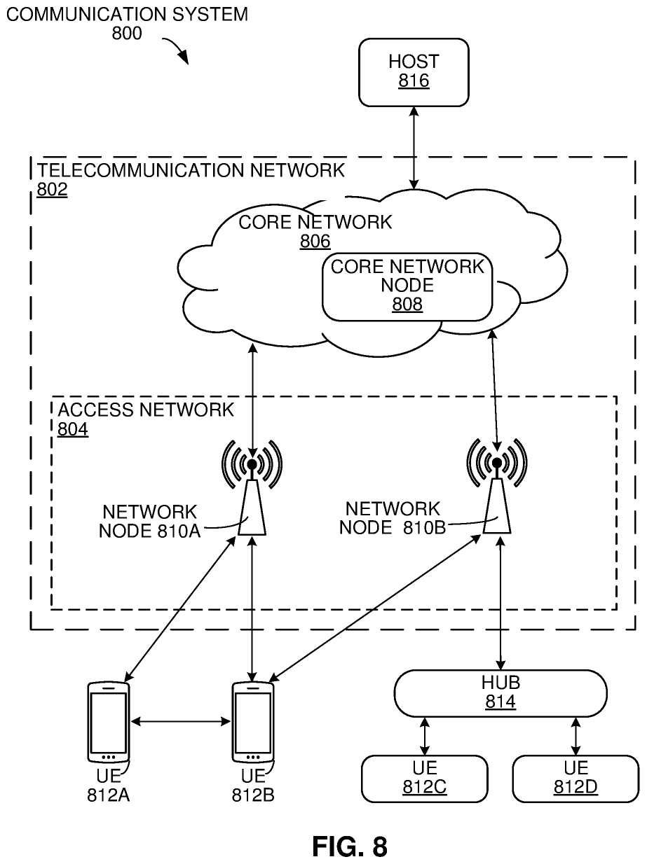

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3rd Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804.Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub-that is, a hub whose primary function is to route communications to/from the UEs from/to the network node 810b. In other embodiments, the hub 814 may be a non-dedicated hub-that is, a device which is capable of operating to route communications between the UEs and network node 810b, but which is additionally capable of operating as a communication start and/or end point for certain data channels.

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M 2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

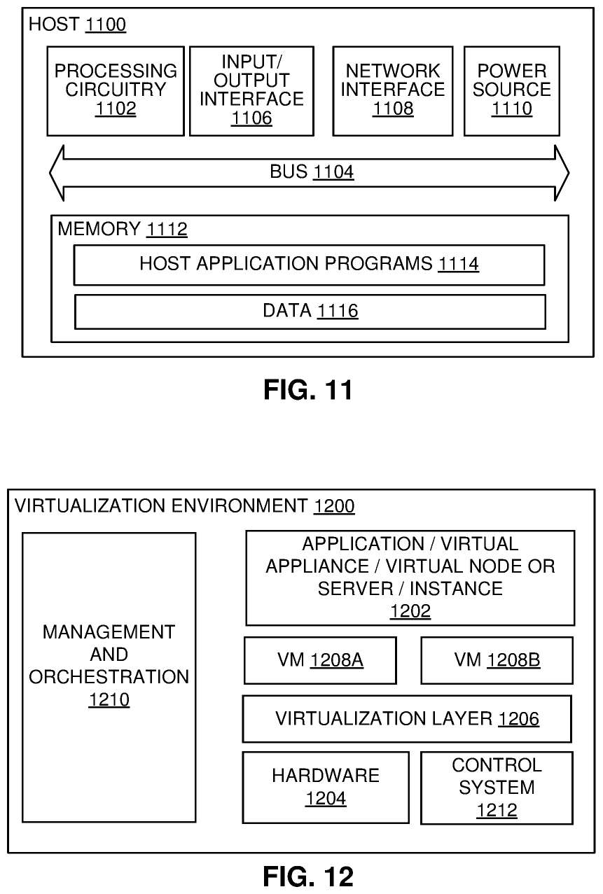

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

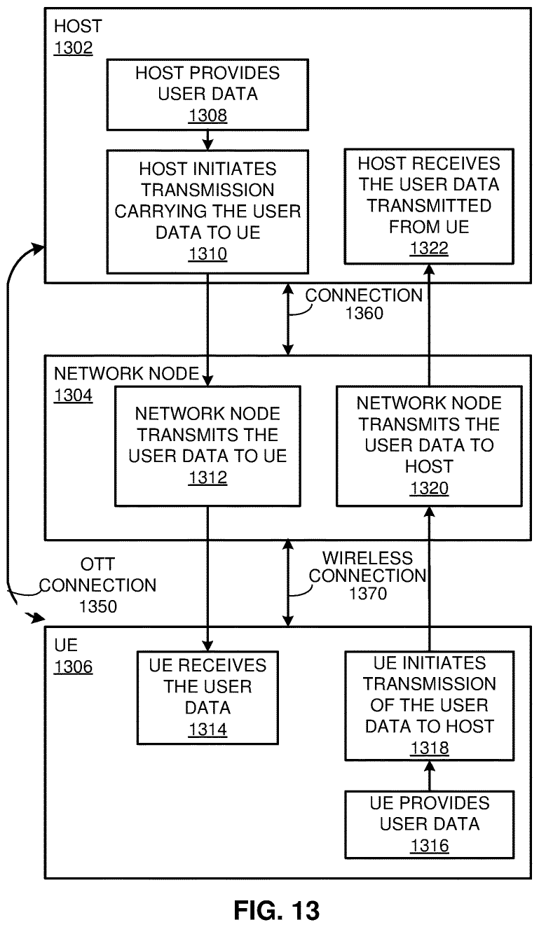

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may provide a way to enable a 5G-based VPN zero touch provisioning by leveraging 5G core features (e.g., secondary authentication). This can include relying on a trigger provided by a telecommunications entity without disclosing any credential to the telecommunications entity.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc. ; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

What is claimed is:

1. A method of operating a communication device communicatively coupled to a communications network, the method comprising:
determining a plurality of dedicated security profiles associated with the communication device;
receiving an authentication query associated with a first dedicated security profile;
determining whether the first dedicated security profile is one of the plurality of dedicated security profiles; and
transmitting a query response based on whether the first dedicated security profile is one of the plurality of dedicated security profiles.

2. The method of claim 1, further comprising:
storing information associated with each dedicated security profile of the plurality of dedicated security profiles in a location accessible by a local profile assistant, LPA, selector,
wherein determining whether the first dedicated security profile is one of the plurality of dedicated security profiles comprises the LPA selector determining whether the first dedicated security profile is one of the plurality of dedicated security profiles based on the information.

3. The method of claim 2, wherein the LPA selector is part of an operating system of the communication device.

4. The method of claim 2,
wherein the LPA selector is part of a LPA of the communication device, the LPA comprising the plurality of dedicated security profiles.

5. The method of claim 2, wherein receiving the authentication query comprises receiving an authentication request associated with a secondary authentication from a dedicated security authenticator that is separate from the communications device.

6. The method of claim 2, wherein determining whether the first dedicated security profile is one of the plurality of dedicated security profiles further comprises
performing an authentication procedure associated with the authentication query.

7. The method of claim 6, wherein performing the authentication procedure associated with the authentication query comprises:
determining, by the LPA selector, an identifier of the first dedicated security profile; and
transmitting the identifier of the first dedicated security profile to at least one of:
a LPA of the communication device;
a modem of the communication device; and
the dedicated security authenticator.

8. The method of claim 6, wherein transmitting the query response comprises transmitting at least one of:
an identifier of the first dedicated security profile; and
credentials stored in the first dedicated security profile.

9. The method of claim 2 wherein determining whether the first dedicated security profile is one of the plurality of dedicated security profiles comprises determining that the first dedicated security profile is not one of the plurality of dedicated security profiles, and
wherein transmitting the query response comprises transmitting an indication that the first dedicated security profile is not one of the plurality of dedicated security profiles.

10. The method of claim 1, wherein the first dedicated security profile comprises an embedded-Subscriber Identity Module, eSIM.

11. A method of operating a dedicated security authenticator, the method comprising:
receiving an authentication request associated with a first dedicated security profile;
performing an authentication procedure by communicating with a local profile assistant, LPA, selector of a communication device; and
transmitting an indication of a result of the authentication procedure to a network node.

12. The method of claim 11, wherein receiving the authentication request comprises receiving the authentication request associated with the first dedicated security profile of a plurality of dedicated security profiles stored on the communication device.

13. The method of claim 12, wherein performing the authentication procedure comprises:
requesting an identifier of the first dedicated security profile from the LPA selector; and
receiving the identifier of the first dedicated security profile from the LPA selector.

14. The method of claim 11 wherein the first dedicated security profile comprises an embedded-Subscriber Identity Module, eSIM.

15. A method of operating a network node in a communications network, the method comprising:
determining information associated with a first dedicated security profile; and
transmitting a message to a local profile assistant, LPA, selector of the communication device, the message including the first dedicated security profile and the information.

16. The method of claim 15, wherein the first dedicated security profile comprises an embedded-Subscriber Identity Module, eSIM.

17. A communication device having a dedicated security authenticator communicatively coupled to a communications network, the communication device comprising:
processing circuitry; and
memory coupled to the processing circuitry and having instructions stored therein that are executable by the processing circuitry to cause the communication device to.
receive an authentication request associated with a first dedicated security profile;
perform an authentication procedure by communicating with a local profile assistant, LPA, selector of a communication device; and
transmit an indication of a result of the authentication procedure to a network node.

18. A computer program comprising program code to be executed by processing circuitry of a communication device communicatively coupled to a communications network, whereby execution of the program code causes the communication device to
determine a plurality of dedicated security profiles associated with the communication device;
receive an authentication query associated with a first dedicated security profile;
determine whether the first dedicated security profile is one of the plurality of dedicated security profiles; and
transmit a query response based on whether the first dedicated security profile is one of the plurality of dedicated security profiles.

19. A computer program product comprising a non-transitory storage medium including program code to be executed by processing circuitry of a communication device communicatively coupled to a communications network, whereby execution of the program code causes the communication device to
determine a plurality of dedicated security profiles associated with the communication device;
receive an authentication query associated with a first dedicated security profile;
determine whether the first dedicated security profile is one of the plurality of dedicated security profiles; and
transmit a query response based on whether the first dedicated security profile is one of the plurality of dedicated security profiles.

20. A non-transitory computer-readable medium having instructions stored therein that are executable by processing circuitry of a communication device configured to
determine a plurality of dedicated security profiles associated with the communication device;
receive an authentication query associated with a first dedicated security profile;
determine whether the first dedicated security profile is one of the plurality of dedicated security profiles; and
transmit a query response based on whether the first dedicated security profile is one of the plurality of dedicated security profiles.

21.-24. (canceled)
